(19) United States
(12) Patent Application Publication
(10) Pub. No.: US 2016/0344261 A1
(43) Pub. Date: Nov. 24, 2016

(54) WHEEL HUB MOTOR

(71) Applicant: Chien-Kuo YEN, Taipei City (TW)

(72) Inventors: Chien-Kuo YEN, Taipei City (TW); Chun-Tun YU, Miaoli County (TW)

(21) Appl. No.: 15/158,338

(22) Filed: May 18, 2016

(30) Foreign Application Priority Data
May 20, 2015 (TW) 104116050

(51) Int. Cl. H02K 9/02; H02K 1/14; H02K 5/20; H02K 1/27; H02K 1/32; B60K 7/00; H02K 1/20

(52) U.S. Cl. CPC H02K 9/02; B60K 7/0007; H02K 1/14; H02K 1/20; H02K 1/2706; H02K 1/32; H02K 5/20

(57) ABSTRACT

A wheel hub motor includes a stator seat, a stator, an air-guiding plate, a rotor and a plurality of permanent magnets. The stator seat defines a plurality of air intake holes. The stator is mounted to the stator seat, and includes a plurality of coils. The air-guiding plate is mounted to the stator seat, and has a plurality of blades. The rotor defines a plurality of air outlet holes, and is mounted with the permanent magnets. The rotor is rotated when the coils are energized. Air flowing via the air intake holes is guided by the blades to flow into a space between the rotor and the stator, and is expelled from the space via the air outlet holes for removing heat generated by the coils.

### CROSS-REFERENCE TO RELATED APPLICATION

This application claims priority of Taiwanese Patent Application No. 104116050, filed on May 20, 2015.

### FIELD

The disclosure relates to a motor, and more particularly to a wheel hub motor including a wind-guiding member.

### BACKGROUND

Referring to FIG. 1, a conventional wheel hub motor 1 is for use in an electric vehicle, and includes a stator seat 11, an annular plate 12, a stator 13, a plurality of permanent magnets 14, a yoke 15, a rotor 16, a magnet-mounting ring 17, a dust cap 18 and an axle member 19.

The stator seat 11 defines a first axle hole 111 and 3 plurality of air intake holes 112. The stator 13 is sleeved on art outer surrounding surface of the stator seat 11, and includes a plurality of projections 131, and a plurality of coils (not shown) that are respectively wound around the projections 131. The permanent magnets 14 surround an outer surrounding surface of the stator 13. The yoke 15 is ring-shaped, and permits the permanent magnets 14 to be mounted thereon. The rotor 16 covers the yoke 15, the permanent magnets 14, the stator 13 and the stator seat 11, and defines a second axle hole 161 and a plurality of air outlet holes 162. The annular plate 12 is co-rotatably connected to a bottom end of the rotor 16. The magnet-mounting ring 17 is for fixedly securing the yoke 15 and the permanent magnets 14 to an inner surrounding surface of the rotor 16. The dust cap 18 is mounted on the rotor 16, The axle member 19 is co-rotatably connected to the rotor 16, and extends through the first axle hole 111 and the second axle hole 161. When the coils of the stator 13 are energized to interact with the permanent magnets 14, the rotor 16 is rotated relative to the stator 13 to drive rotation of the axle member 19. Air flows into an inner space of the rotor 16 via the air intake holes 112 of the stator seat 11, and is expelled via the air outlet holes 162 for removing heat generated by the coils of the stator 13.

However, the heat dissipating mechanism of the conventional wheel hub motor 1 is only suitable for a motor that has an output power smaller than 2.5 kilowatts, and cannot effectively cool down a motor that has an output power of ever 2.5 kilowatts.

### SUMMARY

Therefore, an object of the disclosure is to provide a wheel hub motor that can alleviate the drawback of the prior art.

According to the disclosure, the wheel hub motor includes a stator seat, a stator, an air-guiding plate, a rotor, an axle member and a plurality of permanent magnets. The stator seat defines a first axle hole, and a plurality of air intake holes that are angularly spaced apart from each other and that surround the first axle hole. The stator is mounted to an outer surrounding surface of the stator seat, and includes a plurality of projections, and a plurality of coils that are respectively wound around the projections. The air-guiding plate is mounted to the stator seat, and has an annular body, and a plurality of angularly spaced-apart blades that are disposed on the annular body. The annular body has a first surface that is in contact with the coils and the stator seat, and a second surface that is opposite to the first surface and that permits the blades to be disposed thereon. The rotor covers the stator and the air-guiding plate, is rotatable relative to the stator seat, and defines a second axle hole, and a plurality of angularly spaced-apart air outlet holes that surrounds the second axle hole. The axle member is co-rotatably connected to the rotor, and extends through the first axle hole and the second axle hole. The permanent magnets are disposed on an inner surrounding surface of the rotor. When the coils of the stator are energized to interact with the permanent magnets, the rotor is rotated relative to the stator to drive rotation of the axle member. Air flowing via the air intake holes of the stator seat is guided by the blades of the air-guiding plate to flow into a space between the rotor and the stator, and is expelled from the space between the rotor and the stator via the air outlet holes for removing heat generated by the coils.

### BRIEF DESCRIPTION OF THE DRAWINGS

Other features and advantages of the disclosure will become apparent in the following detailed description of the embodiment with reference to the accompanying drawings, of which:

FIG. 1 is an exploded perspective view illustrating a conventional wheel hub motor;

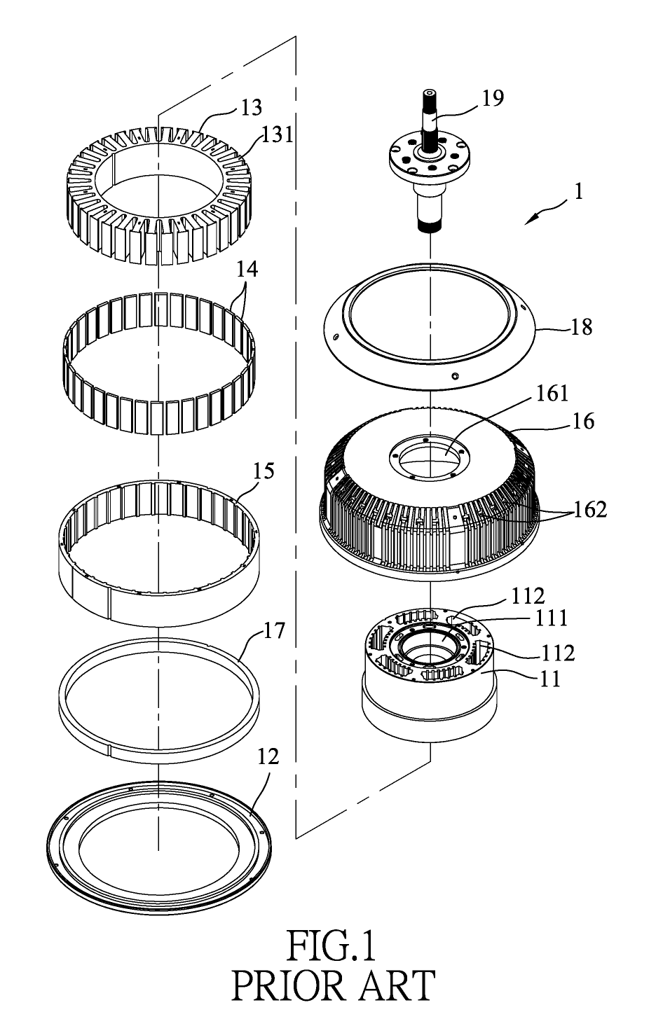

FIG. 2 is an exploded perspective view illustrating an embodiment of the wheel hub motor according to the disclosure;

FIG. 3 is a sectional view illustrating a stator and an air-guiding plate of the embodiment; and

FIG. 4 is a perspective view illustrating a rotor of the embodiment.

### DETAILED DESCRIPTION

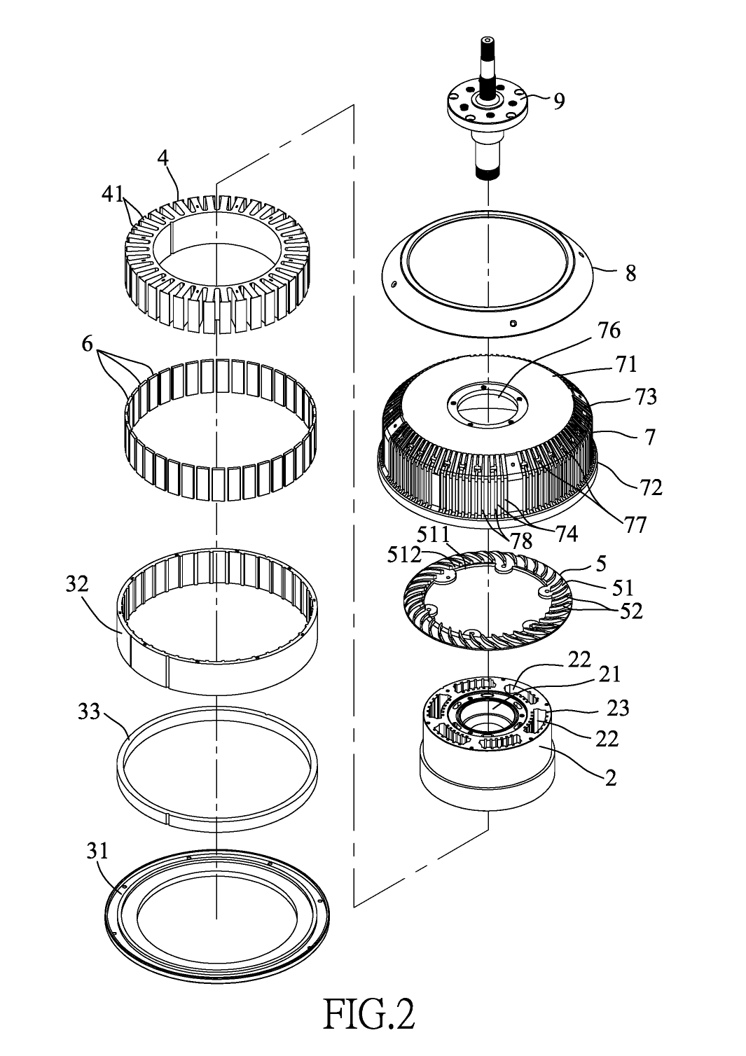

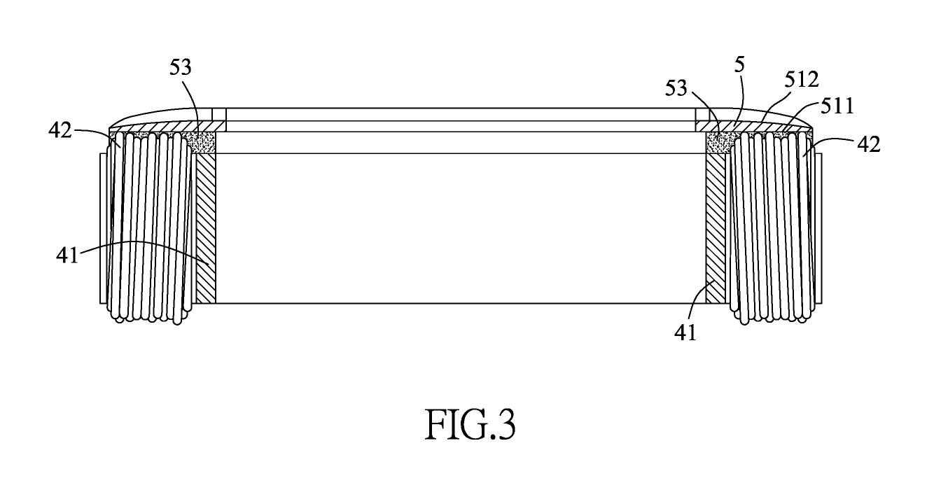

Referring to FIGS. 2 and 3, the embodiment of the wheel hub motor according to the disclosure includes a stator seat 2, an annular plate 31, a stator 4, an air-guiding plate 5, a thermally conductive layer 53, a plurality of permanent magnets 6, a yoke 32, a rotor 7, a magnet-mounting ring 33, a dust cap 8 and an axle member 9.

The stator seat 2 defines a first axle hole 21, and a plurality of air intake holes 22 that are angularly spaced apart from each other and that surround the first axle hole 21. The stator seat 2 has a plurality of inner surfaces that respectively define the air intake holes 22, and a plurality of fins that are formed on the inner surfaces for increasing surface area so as to enhance heat-dissipating efficiency.

The stator 4 is sleeved on an outer surrounding surface of the stator seat 2, and includes a plurality of projections 41, and a plurality of coils 42 (see FIG. 3) that are respectively wound around the projections 41.

The air-guiding plate 5 is fixedly mounted to the stator seat 2, and has an annular body 51, and a plurality of angularly spaced-apart blades 52 that are disposed on the annular body 51. The annular body 51 has a first surface 511 that is in contact with the coils 42 and the stator seat 2, and a second surface 52 that is opposite to the first surface 511 and that permits the blades 52 to be disposed thereon. Each of the blades 52 extends spirally, and has a streamlined shape. In one embodiment, each of the blades 52 is arc-shaped.

The thermally conductive layer 53 maybe constituted of grease, and is disposed between the stator 4 and the first surface 511 of the annular body 51 of the air-guiding plate 5 for aiding heat transfer from the coils 42 to the air-guiding plate 5. In one embodiment, the thermally conductive layer 53 may be constituted of insulating material for preventing electrical leakage when an insulating cover of at least one of the coils 42 is fractured.

The permanent magnets 6 surround an outer surrounding surface of the stator 4.

The yoke 32 is ring-shaped, and is co-rotatably mounted to an inner surrounding surface of the rotor 7 to permit the permanent magnets 14 to be mounted on an inner surrounding surface thereof. The yoke 32 is for minimizing magnetic leakage.

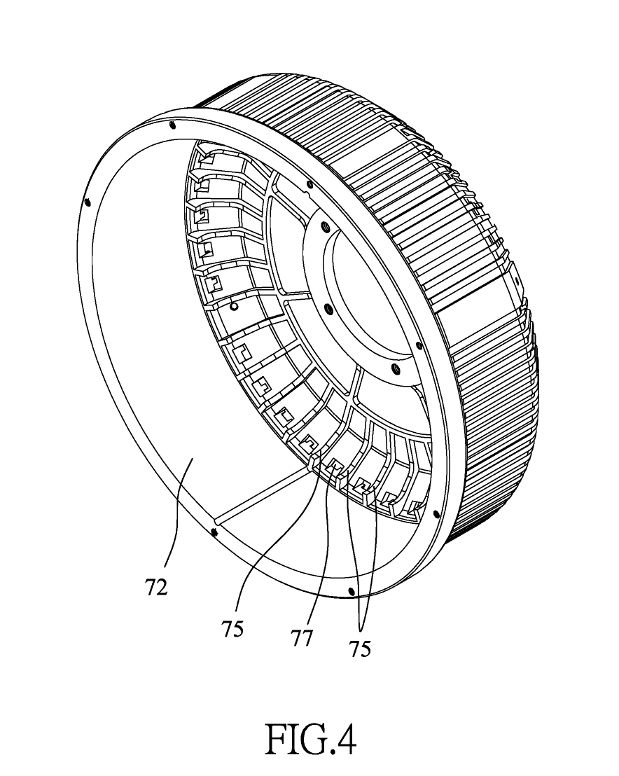

Referring further to FIG. 4, the rotor 7 covers the yoke 32, the permanent magnets 6, the stator 4, the air-guiding plate 5 and the stator seat 2, and is rotatable relative to the stator 4, the air-guiding plate 5 and the stator seat 2. The annular plate 31 is co-rotatably connected to an end of the rotor 7. The rotor 7 has a base wall 71 that is disposed at one side of the air-guiding plate 5 opposite to the stator 4 and that is spaced apart from the permanent magnets 6, a surrounding wall 72 that surrounds the yoke 32 and the permanent magnets 6, a frustoconical wall 73 that is connected between the base wall 71 and the surrounding wall 72 and that converges toward the base wall 71, a plurality of angularly spaced-apart outer ribs 74 that are disposed on an outer surrounding surface of the surrounding wall 72 and an outer surrounding surface of the frustoconical wail 73, and a plurality of angularly spaced-apart inner ribs 75 that are disposed on an inner surrounding surface of the frustoconical wall 73 and that extend radially. The base wall 71 defines a second axle hole 76. The frustoconical wall 73 defines a plurality of angularly spaced-apart air outlet holes 77 that surround the second axle hole 76. Each of the air outlet holes 77 is located between two adjacent ones of the inner ribs 75. Two adjacent ones of the outer ribs 74 cooperatively define an air guiding groove 78 therebetween along which the air expelled via the air outlet holes 77 flows.

Referring to FIGS. 2 and 3, the magnet-mounting ring 33 surrounds the stator seat 2, and is disposed on the annular plate 31 for fixedly securing the yoke 32 and the permanent magnets 6 to an inner surrounding surface of the rotor 7. It should be noted that, in a variation of the embodiment, the yoke 32 may be omitted, and the magnet-mounting ring 33 is disposed on the annular plate 31 for fixedly securing the permanent magnets 6 to the inner surrounding surface of the rotor 7.

The dust cap 18 is mounted on the frustoconical wall 73 of the rotor 7 for preventing dust or water droplet from entering the rotor via the air outlet holes 77.

The axle member 9 is co-rotatably connected to the rotor 7, and extends through the first axle hole 21 and the second axle hole 76.

When the coils 42 of the stator 4 are electrically energized to interact with the permanent magnets 6, the rotor 7 is rotated relative to the stator 4 to drive rotation of the axle member 9. During operation of the wheel hub motor of this disclosure, air flows via the air intake holes 22 of the stator seat 2, and is guided by the blades 52 of the air-guiding plate 5 to flow into a space between the rotor 7 and the stator 4 for removing heat generated by the coils 42 of the stator 4. The blades 52 are configured to increase the surface area of the air-guiding plate 5 through which the air passes, and to reduce formation of turbulent flow so as to reduce air resistance acting opposite to the airflow. The heated air is then expelled from the space between the rotor 7 and the stator 4 via the air outlet holes 77, and is guided to flow along the air guiding grooves 78 defined among the outer ribs 74.

To sum up, the thermally conductive layer 53 aids heat transfer from the coils 42 to the air-guiding plate 5, and the air-guiding plate 5 is configured to increase the surface area through which the air passes and to reduce the air resistance acting opposite to the airflow. As a result, the heat dissipating mechanism of the wheel hub motor of this disclosure can effectively remove heat generated by the coils 42 and is suitable for a motor that has an output power of over 2.5 kilowatts.

In the description above, for the purposes of explanation, numerous specific details have been set forth in order to provide a thorough understanding of the embodiment. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A wheel hub motor comprising:
a stator seat defining a first axle hole, and a plurality of air intake holes that are angularly spaced apart from each other and that surround said first axle hole;
a stator mounted to an outer surrounding surface of said stator seat, and Including a plurality of projections, and a plurality of coils that are respectively wound around said projections;
an air-guiding plate mounted to said stator seat, and having an annular body, and a plurality of angularly spaced-apart blades that are disposed on said annular body, said annular body having a first surface that is in contact with said coils and said stator seat, and a second surface that is opposite to said first surface and that permits said blades to be disposed thereon;
a rotor covering said stator and said air-guiding plate, rotatable relative to said stator seat, and defining a second axle hole, and a plurality of angularly spaced-apart air outlet, holes that surrounds said second axle hole;
an axle member co-rotatably connected to said rotor, and extending through said first axle hole and said second axle hole; and
a plurality of permanent magnets disposed on an inner surrounding surface of said rotor;
wherein, when said coils of the stator are energized to interact with said permanent magnets, said rotor is rotated relative to said stator to drive rotation of said axle member, air flowing via said air intake holes of said stator seat being guided by said blades of said air-guiding plate to flow into a space between said rotor and said stator, and being expelled from said space between said rotor and said stator via said air outlet holes for removing heat generated by said coils.

2. The wheel hub motor as claimed in claim 1, further comprising a thermally conductive layer that is disposed between said stator and said first surface of said annular body of said air-guiding plate for aiding heat transfer from said coils to said air-guiding plate.

3. The wheel hub motor as claimed in claim 1, wherein each of said blades of said air-guiding plate is arc-shaped.

4. The wheel hub motor as claimed in claim 1, wherein said rotor has a base wall that is disposed at one side of said air-guiding plate opposite to said stator, that is spaced apart from said permanent magnets, and that defines said second axle hole, a surrounding wall that surrounds said permanent magnets, and a frustoconical wall that is connected between said base wall and said surrounding wall and that converges toward said base wall, said air outlet holes being formed in said frustoconical wall.

5. The wheel hub motor as claimed in claim 4, wherein said rotor further has a plurality of angularly spaced-apart outer ribs that are disposed on an outer surrounding surface of said surrounding wall and an outer surrounding surface of said frustoconical wall, two adjacent ones of said outer ribs cooperatively defining an air guiding groove therebetween along which the air expelled via said air cutlet holes flows.

6. The wheel hub motor as claimed in claim 4, wherein said rotor further has a plurality of angularly spaced-apart inner ribs that are disposed on an inner surrounding surface of said frustoconical wall and that extend radially, each of said air outlet holes being located between two adjacent ones of said inner ribs.

7. The wheel hub motor as claimed in claim 1, further comprising a yoke that is mounted to said inner surrounding surface of said rotor and that permits said permanent magnets to be mounted on an inner surrounding surface thereof.

8. The wheel hub motor as claimed in claim 7, further comprising a magnet-mounting ring that is for fixedly securing said yoke and said permanent magnets to said inner surrounding surface of said rotor.

9. The wheel hub motor as claimed in claim 1, further comprising a magnet-mounting ring that is for fixedly securing said permanent magnets to said inner surrounding surface of said rotor.

10. The wheel hub motor as claimed in claim 1, wherein said stator seat has a plurality of inner surfaces that respectively define said air intake holes, and a plurality of fins that are formed on said inner surfaces.
